(19) United States
(12) Patent Application Publication
(10) Pub. No.: US 2026/0197317 A1
(43) Pub. Date: Jul. 9, 2026

(54) SYSTEM AND METHOD FOR OPERATING ELECTRIC DEVICES

(71) Applicant: Stefaan Penne, Hofstade (BE)

(72) Inventor: Stefaan Penne, Hofstade (BE)

(21) Appl. No.: 19/133,877

(22) PCT Filed: Dec. 1, 2022
(86) PCT No.: PCT/IB2022/061631

§ 371 Date: May 29, 2025

(51) Int. Cl. H04L 9/40

(52) U.S. Cl. CPC H04L 63/102; H04L 63/0853

(57) ABSTRACT

A method for providing authorized access to and control of electric devices using a controller connectable to a server via the internet. The controller includes a unique identifier and one or more control channels for controlling operation of a corresponding electric device. The method includes: activating the controller; authenticating identity of the controller, receiving user identification data from a personal device on the server and authenticating identity of the user, verifying whether the identified user is authorized to control the controller, enabling the identified user to control the electric devices connected to the matching controller from the personal device in accordance with a user specific profile.

### CROSS-REFERENCE TO RELATED APPLICATION

The present application is the National Phase entry of International Patent Application No. PCT/IB2022/061631 filed Dec. 1, 2022, the entire contents of which is hereby incorporated by reference into this application.

### TECHNICAL FIELD

The present disclosure relates to systems and methods for providing authorized access and control to electric devices.

More specifically the disclosure is dedicated to enable people operating new and/or existing electric devices at home, in the office or other environment with an authorized key.

### BACKGROUND

Traditionally keys are used to mechanically lock or unlock doors or gates. Such keys are usually lock specific meaning that for each door or gate a separate key is required. As a result people end up with a bunch of keys which they need to carry around to ensure appropriate access when needed. Moreover, for some locks plenty of people need access. As a consequence a lot of the same keys are circulating, hence enhancing the chance of losing keys. In case of loss for safety reasons locks need to be replaced which is quite a burden not only because of cost but also from key management perspective as authorized people need a key replacement and have no access till their key is replaced.

It is known to lock or unlock electric doors or gates using electronic keys. Such key is read-out by a reading unit on of in the vicinity of the door or gate and if the signal read-out matches an actuator is activated to unlock the door or gate. Electronic keys may be provided with a transmitter for transmitting a wireless signal such as an RF signal which is picked up by a receiver which responsive thereto in case of detecting a matching signal allows to perform the requested action such as for example in case of a garage door opening or closing the door. In case of loss or changes in access authorization, electronic keys clearly have an aspect compared to mechanic keys in that the receiving unit can be reprogrammed such that access with the lost key or unauthorized or undesired access by a specific key can be easily prevented. A further aspect of electronic keys is that the receiving unit can be programmed to add functionality beyond just locking or unlocking a door or gate but also for example to restrict access for the key holder for example to office hours on working days.

A disadvantage however is that typically, as each brand uses its own dedicated system and signal frequencies, there is still a one to one relationship between key and receiving unit, and by consequence necessitating a dedicated key for each application. Hence as a key holder the burden to ensure to always carry along the right selection of keys as well as to carry along a whole bunch of keys still exist. The owner or manager of the electric devices also still has the burden to manage access and control to each electric device separately which is time consuming and difficult to keep it transparent who has access to what and with which functionality and thus inherently prone to errors. Moreover the wireless signal between transmitter and receiving unit is subject to interference and hacking which is undesired from a security and safety point of view.

### SUMMARY

It is therefore an objective of the present disclosure to provide an alternative solution which overcomes one or more of the above-mentioned disadvantages.

To this end, the present disclosure concerns a method for providing authorized access to and control of electric devices using at least one controller connectable to a remote processor on a server via the internet and each controller comprising a unique identifier and one or more control channels, wherein each of the control channels is electrically connectable to a corresponding electric device for controlling operation thereof. The method comprises the steps of
activating the controller by powering up the controller, by electrically connecting each of the electrical devices to be controlled to a corresponding control channel, by connecting the controller to the internet, and by inputting control parameters for each channel for controlling operation of the electrical device connected thereto,
authenticating identity of the controller by consulting a database on the server accessible to the remote processor using the unique identifier.

Typically the unique identifier of each controller is provisioned during manufacturing of the controller. It is further ensured that this unique identifier is also stored in a location accessible to the server, for example a database stored in a memory connected to the remote processor of the server. When authenticating identity of a controller, the unique identifier is compared with the stored identifiers. In case of a positive match the connection between server and controller is maintained. In case the authentication fails the connection between the controller and the server is disrupted.

Upon activation the controller is capable of executing control actions on the electric devices connected thereto subject to triggers received via the server. The server is set-up in a secured environment were all data is encrypted. In embodiments, the communication between the remote processor of the server and the controller is encrypted. In embodiments, the connections electrically connecting each of the electrical devices to be controlled to a corresponding control channel of the controller as well as the connections connecting the controller to the internet are solely wired connections. In the latter case, as remote control of the electric devices connected to the controller is only possible through the server via wired connections it is nearly impossible to remotely hack or otherwise interfere with the operation of the electric devices connected to the controller. This ensures a secure and safe configuration.

The electric devices can be any devices for which it is desirable to have remote access and/or control whether at home, at the office or any other professional environment, or any other environment including but not limited to leisure-related environments such as for example hotels and B&B's, facilities for sports or other leisure activities, car parks, etc. Examples comprise devices selected from doors, gates, garage doors, mailboxes, lights, heating, cooling, ventilation, pools, pumps, motors, printers, copiers, window coverings, sunscreens and other appliances including domestic appliances.

The control parameters can be any parameter allowing to control a certain functionality of an electric device connected to the controller. Examples comprise parameters selected from parameters controlling the function of locking, unlocking, turning on, turning off, dimming, delaying, opening, and closing, and/or for time managed control.

The method according to the present disclosure further comprises the steps of:
receiving user identification data from a personal device connected to the internet on the remote processor;
authenticating identity of the user,
verifying by consulting a database on the server accessible to the remote processor whether the identified user is authorized to control the controller, and in case of a positive match retrieving a user specific profile associated with the matching controller from the database specifying selected control parameters and selected channels that the identified user is authorized to control,
enabling the identified user to control the electric devices connected to the matching controller from the personal device in accordance with the user specific profile.

Examples of personal devices include but are not limited to PC's, smartphones, tablets, desktops and laptops.

When an identified user issues a control trigger on the personal device, then this is communicated to the server, processed by the remote processor and communicated to the controller that upon receipt executes the corresponding control action or actions on the electric devices. Hence there is no direct communication between the personal device and the controller as all communication goes via the server operating in a secure environment. The user specific profile determines which electric devices the identified user is allowed to control and also which functionality. The user specific profiles can be set-up initially by a recognized installer of the controller or by the owner. Once set-up, change management of the user specific profiles can be handled by the owner or by a administrator delegated by the owner. This change management may include adding new user specific profiles for the controller concerned.

In an embodiment of the present disclosure, an identified user is enabled to control the electric devices connected to the matching controller through a user interface of an app installed on the personal device, the user interface being configured in accordance with the user specific profile.

In another embodiment of the present disclosure, the method further comprises the steps of:
determining a location of the controller, and
communicating the controller location to the remote processor for storage in the database. The location of the controller can be used to support authentication of the controller and/or may be used for tracking the controller. More over one may also opt to adapt the user specific profile such as to include a geofencing zone for at least one of the selected control parameters and/or selected channels wherein the identified user is authorized to remotely control the at least one of the selected control parameters and/or selected channels. Doing so not only prevents unwanted control action caused by accidental triggers outside the geofencing zone, but also enhances capabilities to limit and/or other manage control possibilities to the needs while ensuring maximum security.

The present disclosure allows to connect plural users and plural controllers to the server. It is also possible to authorize control for a same user to plural controllers such as for example a controller at work and a controller at home. In the latter case the step of verifying according to the method of the present disclosure may result in plural positive matches. For each of the positive matches a user and controller specific profile associated with the corresponding matching controller is retrieved from the database specifying selected control parameters and selected channels that the identified user is authorized to control, and that the identified user is enabled to control the electrical devices connected to each matching controller from the personal device in accordance with the user and controller specific profile associated therewith.

The present disclosure also concerns a system for providing authorized access to and control of electrical devices comprising a controller connectable to a remote processor via the internet and having a unique identifier, the controller comprising one or more control channels, wherein each of the control channels is electrically connectable to a corresponding electrical device for controlling operation thereof, the system being configured to execute the steps of the method a described in the embodiments here above or a combination thereof.

### BRIEF DESCRIPTION OF THE DRAWINGS

With the intention of better showing the characteristics of the present disclosure, hereafter, as an example without any limitative character, a form of embodiment is described of an improved device, with reference to the accompanying drawings, wherein:

FIG. 1 Schematically Represents Controllers integrated in a system for providing authorized access to and control of electrical devices connected to the controllers according to an embodiment of the present disclosure;

FIG. 2 schematically depicts workflow for authorizing a user to control a controller according to an embodiment of the present disclosure.

### DETAILED DESCRIPTION

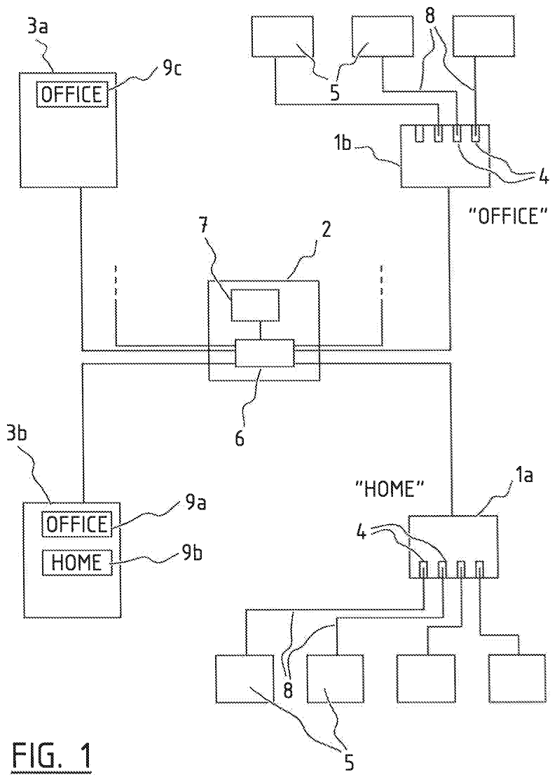

FIG. 1 depicts a system for providing authorized access to and control of electrical devices 5. Two controllers 1a, 1b are connected to a processor 6 of a remote server 2. Although the example depicted shows two controllers, in practice any number of controllers may be connected to the server 2. As an example to improve understanding one of the controllers is labeled “home” representing a controller la operating at home of a user, the other controller is labeled “office” representing the office work place of one or more users. Each of the controllers 1a, 1b is provided with firmware and a unique identifier that are provisioned during manufacturing of the controllers. During lifetime of a controller 1a, 1b it is possible to change the identifier, the change however being such that also the changed identifier is unique. The controllers 1a, 1b are powered by connecting them to the mains. Alternatively a battery or other power source may be provided.

Each controller 1a, 1b is provided with channels 4 to which electric devices 5 can be connected. As an example the controllers depicted in FIG. 1 are each provided with four channels 4. To each channel 4 of the “home” controller 1a an electric device 5 is connected, while one of the channels 4 of the “office” controller 1b is still open. The electric devices 5 to the respective controllers by electric wires 8. Typical examples of electric devices are doors or gates, provided with actuators and/or sensors and/or motors respectively to unlock, monitor status of or opening the doors or gates, lights, motors, domestic appliances such as for instance coffee machines, heating and cooling devices, and air circulation devices.

The controllers are connected to the internet via a LAN cable. The remote server 2 is running in the cloud, for example on Microsoft Azure or Amazon AWS, or on the IT infrastructure of the application owner or a provider, and hence accessible through the internet. The remote sever may be at least partly managed by the application owner. In use, when the controllers 1a, 1b are activated, the communication between each of the controllers and the server is via a secure connection such as for example an MQTTS connection, where the server acts as broker and each of the controllers as client. The data communicated is secured and encrypted using the MQTTS protocol which together with the other security precautions taken allows to keep the data exchanged confidential.

The server 2 comprises a processor 6 connected to a memory 7 whereon a database is stored. In operation, the back end of the application software driving the system for providing authorized access to and control of electrical devices is running on the server and forms together with the database a secure data room. All communication in the data room is encrypted. In operation, the front end of the application is installed on a personal device of a user. The user can be anybody who is authorized or attempts to become authorized to use and or access the application software such as an end-user, an installer of a controller, an owner of a controller or its delegate, and the database administrator.

In FIG. 1 a personal device 3a of a first end user and a personal device 3b of a second end user are shown, each of the personal devices 3a, 3b is connected to the server 2 via the internet using HTTPS. Although the example depicted shows two personal devices each associated with a different user, in practice any number of users may be connected to the server 2 through their personal device and users are allowed to use plural personal devices. The personal devices of the embodiment shown in FIG. 1 are mobile devices. Examples of mobile devices include smartphones, tablets and laptops. The mobile devices 3a, 3b have a connection to the internet which can be wired or wireless. In operation when the end user has been authenticated and has installed the front end of the software application on its mobile device, then when using the software application the end user can visualize on his display the user interface of the controller to which he has access. Alternatively the authenticated user can access the application software made available through the Web.

In the example shown the first end user using mobile device 3a has access to the controller 1b labelled “office”. In this example on the display the mobile device 3a in the user interface entry 9c the matching controller 1b is displayed using the same name. Obviously the end user can also change the name in the user interface dependent on how he wishes to refer to the controller 1b. The second end user using mobile device 3b has access to the controller 1b labelled “office” and to the controller la labelled “home”. In this example on the display of the mobile device 3b in the user interface entry 9a the matching controller 1b is displayed using the same name “office”, while in the user interface entry 9b the matching controller la is displayed using the same name “home”.

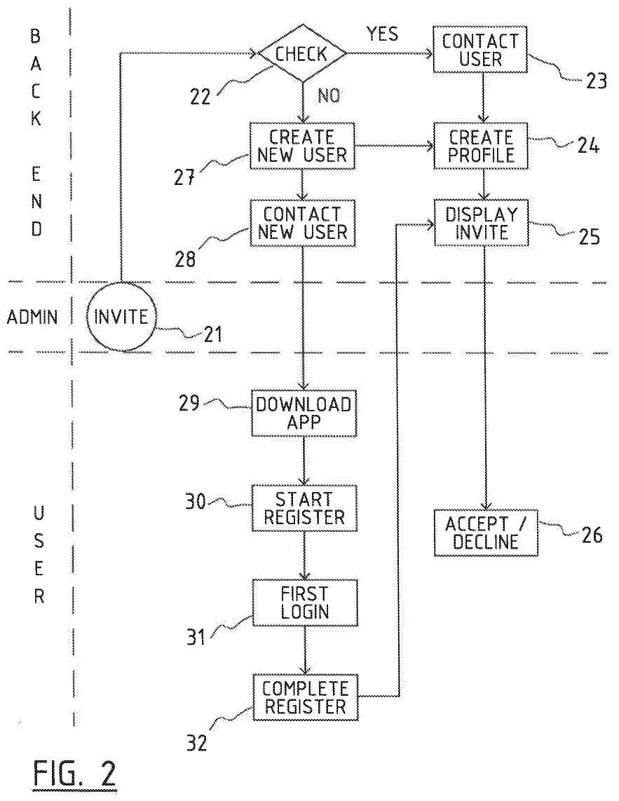

The operation of the system as shown in FIG. 1 is explained with reference to FIGS. 1 and 2.

Each controller 1a, 1b is activated by powering up the controller, by electrically connecting each of the electrical devices 5 to be controlled to a corresponding control channel 4 using electric wires 8, and by connecting the controller to the internet using a LAN Cable. In case of first time use or in case a change of configuration is desired, control parameters for each channel 4 are set-up or adapted allowing to control a certain functionality of an electric device connected to the controller. In case the electric device is a door or gate, control parameters may be set-up for controlling a door actuator, or for controlling a motor to open or close the door. In case the electric device is a light, control parameters may be set-up for switching the light on or off, or for dimming the light, etc.

Upon activation the unique identifier of each controller 1a, 1b is communicated to the server 2 via a secure connection such as for example a MOTTS connection. The controller unique identifier communicated is compared with a list of unique identifiers of controllers stored in a database after production of the controllers. If the verification is positive the connection is maintained otherwise the controller concerned is disconnected from the server. In case the controller is activated for the first time the control parameters of the channels of the controller are set-up using a default setting or customized usually by the installer or owner of the controller. The resulting configuration is stored in the database linked to the stored matching unique identifier. This configuration can be adapted, usually by the owner or his delegate when deemed appropriate, e.g. when adding functionality or connecting additional electric devices to unused channels.

Hence, now responsive to triggers the controllers can be operated remotely within the limits of the stored configuration by users dependent on their rights and authorization. User rights are managed by the owner of the controller or by an administrator in case this responsibility is delegated.

In accordance with the workflow depicted in FIG. 2, the administrator who wants to authorize a user to control a controller 1a, 1b logs into the software application running on the server 2. After the identity and the rights of the administrator are verified, the administrator is allowed to enter an invite 21 by entering for example an e-mail address of the user. In the back end of the software application running on the server 2 it is checked 22 whether the e-mail address entered exists in the database stored on the memory 7.

In case the e-mail address matches an existing address in the database, the user is contacted 23 by sending an e-mail including a link to the software application. A user and controller specific profile is created 24 and stored in the database linking the user to the controller 1a, 1b and specifying which channels 4 and control parameters can be accessed and/or controlled by the user within the limits of the stored configuration of the controller. The invite coupled to the user and controller specific profile is displayed 25 in the software application allowing the user to accept or decline using the front end of the application software on its mobile device 3a, 3b. The invited user is requested to accept or decline 26 the invite.

In case there is no match of the e-mail address with an existing address in the database, an initial record is created 27 in the database for the new user. A user and controller specific profile is created 24 and stored in the database linking the new user to the controller 1a, 1b and specifying which channels 4 and control parameters can be accessed and/or controlled by the new user within the limits of the stored configuration of the controller. The new user is contacted 28 by e-mail including a link to download the software application and to register. The new user can download the app 29 on its mobile device 3a, 3b and initiate 30 the registration process by entering his identity data such as first name, last name, e-mail address, mobile number and password. When entered these data are used in the back end to complement the initial created in the database for the new user. The communication between the front end of the software application on the mobile device 3a, 3b and the data room is via HTTPS. User authentication and verification of its authorization is done via identification data for example in the form of a Token, such as a Web Token, generated when logging into the software application. When a new user logs in for the first time 31 a temporary Web Token is generated allowing the new user to go through the registration process. Use is made of two-factor authentication. A code is sent to the mobile number of the new user which has to be entered on his mobile device to verify the mobile device. Subsequently, the register link attached to the e-mail sent to the new user 28 needs to be activated to verify the e-mail with the link. In case successful, the registration process is completed 32. The invite coupled to the user and controller specific profile is displayed 25 in the software application allowing the new user to accept or decline using the front end of the application software on its mobile device 3a, 3b. The new user is requested to accept or decline 26 the invite.

To control electric devices in accordance with his authorization an authenticated user who is logged into the software application via his mobile device 3a, 3b sees on his display user interface entries 9a, 9b, 9c which are configured such that when activated enable the user to control the electric devices connected to the corresponding controller from the mobile device in accordance with the user and controller specific profile. For example as shown in FIG. 1, the first end user of mobile device 3a sees on his display the UI entry 9c “office” enabling him to control the electric devices 5 connected to “office” controller 1b in accordance with his authorization as defined in its user and controller 1b specific profile. The second end user of mobile device 3b sees on its display two UI entries being entry 9a “office” and entry 9b “home”. The second user is hence enabled respectively to control the electric devices 5 connected to “office” controller 1b in accordance with his authorization as defined in its user and controller 1b specific profile as well as the electric devices 5 connected to “home” controller la in accordance with his authorization as defined in its user and controller la specific profile.

The present disclosure is in no way limited to the form of embodiment described by way of an example and represented in the figures, however, such an improvement for providing authorized access to and control of electric devices can be realized in various forms without leaving the scope of the disclosure.

1. A method for providing authorized access to and control of electric devices, each of the electric devices is electrically connectable to a corresponding control channel of a controller for controlling operation of the electric devices, the controller is connectable to a remote processor on a server via the internet, and the controller comprises unique identifier method comprising:
activating the controller by powering up the controller, by electrically connecting each of the electrical devices to be controlled to the corresponding control channel, by connecting the controller to the internet, and by inputting control parameters for each control channel for controlling operation of the electrical device connected thereto;
authenticating identity of the controller by consulting a database on the server accessible to the remote processor using the unique identifier;
receiving user identification data from a personal device connected to the internet on the remote processor;
authenticating identity of the user;
verifying by consulting the database whether the identified user is authorized to control the controller, and in case of a positive match retrieving a user specific profile associated with the matching controller from the database specifying selected control parameters and selected channels that the identified user is authorized to control; and
enabling the identified user to control the electric devices connected to the matching controller from the personal device in accordance with the user specific profile.

2. The method according to claim 1, wherein connections electrically connecting each of the electrical devices to be controlled to a corresponding control channel of the controller and connecting the controller to the internet are solely wired connections.

3. The method according to claim 1 further comprising of:
determining a location of the controller; and
communicating the controller location to the remote processor for storage in the database.

4. The method according to claim 3, wherein the user specific profile specifies a geofencing zone for at least one of the selected control parameters and/or selected channels, wherein the identified user is authorized to remotely control the at least one of the selected control parameters and/or selected channels.

5. The method according claim 1, wherein claims, characterized in that the identified user is enabled to control the electric devices connected to the matching controller through a user interface of an app installed on the personal device the user interface being configured in accordance with the user specific profile.

6. The method according to claim 1, wherein the communication between the controller and the remote processor is encrypted.

7. The method according to claim 1 further comprising disconnecting the controller from the remote processor in case the identity of the controlled could not be authenticated.

8. The method according to claim 1, wherein verifying results in plural positive matches and the identified user is authorized to control multiple controllers, then for each of the positive matches a user and controller specific profile associated with the matching controller is retrieved from the database specifying selected control parameters and selected channels that the identified user is authorized to control, and that the identified user is enabled to control the electrical devices connected to each matching controller from the personal device in accordance with the user and controller specific profile associated therewith.

9. The method according to claim 1, wherein the electric devices comprise devices selected from doors, gates, garage doors, mailboxes, lights, heating, cooling, ventilation, pools, pumps, motors, printers, copiers, window coverings, sunscreens and other appliances including domestic appliances.

10. The method according to claim 1, wherein the control parameters comprise parameters selected from parameters controlling the function of locking, unlocking, turning on, turning off, dimming, delaying, opening, and closing.

11. A system for providing authorized access to and control of electrical devices comprising a controller connectable to a remote processor via the internet and having a unique identifier, the controller comprising one or more control channels (4), wherein each of the electrically devices is electrically connectable to a corresponding control channel for controlling operation thereof, the system being configured to execute the steps of the method according to claim 1.
